(19) United States
(12) Patent Application Publication
(10) Pub. No.: US 2024/0205687 A1
(43) Pub. Date: Jun. 20, 2024

(54) APPARATUS AND METHOD FOR HANDLING SOR SECURITY CHECK FAILURE IN CONNECTED MODE OF UE IN WIRELESS NETWORK

(71) Applicant: Samsung Electronics Co., Ltd., Suwon-si, Gyeonggi-do (KR)

(72) Inventors: Lalith KUMAR, Bangalore (IN); Arijit SEN, Bangalore (IN); Danish Ehsan HASHMI, Bangalore (IN); Koustav ROY, Bangalore (IN)

(21) Appl. No.: 18/285,772

(22) PCT Filed: Apr. 8, 2022
(86) PCT No.: PCT/KR2022/005100

§ 371 Date: Oct. 5, 2023

(30) Foreign Application Priority Data
Apr. 10, 2021 (IN) 202141016876
Mar. 31, 2022 (IN) 2021 41016876

(51) Int. Cl. H04W 12/72; H04W 8/06; H04W 12/61; H04W 48/18; H04W 60/06; H04W 84/04

(52) U.S. Cl. CPC H04W 12/72; H04W 8/06; H04W 12/61; H04W 48/18; H04W 60/06; H04W 84/042

(57) ABSTRACT

The present disclosure relates to a 5G communication system or a 6G communication system for supporting higher data rates beyond a 4G communication system such as long term evolution (LTE).

### TECHNICAL FIELD

The present disclosure relates to a wireless network, and more specifically related to a method and a User Equipment (UE) for handling a Steering of roaming (SoR) security check failure in a connected mode of the UE in the wireless network.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network per-formances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collison avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mecahnisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The principal object of the embodiments herein is to provide a method and a UE for handling SoR security check failure in a connected mode of the UE in a wireless network.

Another object of the embodiments herein is to configure, by a HPLMN apparatus, a “SoR security check timer” as part of SOR-CMCI configuration in the UE. When the UE receives the SOR information, if the SOR security check is not successful then, the UE starts SoR security check timer (also called as Tsor-CM timer related to SoR security failure crictrion) configured by the HPLMN in the UE. Further, the UE executes a deregistration procedure to come into an IDLE state, when the SoR security check timer (Tsor-CM) timer expires. After coming into IDLE state UE executes PLMN selection procedure to select some other VPLMN. After security check failure, the UE starts the timer after expiry of the timer, the UE will deregister from current VPLMN, release all resources including NAS signalling connection and select some other VPLMN. Thus, the UE is no more dependent on a VPLMN to release the NAS signalling connection and thus the VPLMN cannot act maliciously.

### Solution to Problem

Accordingly, the embodiment herein is to provide a method for handling Steering of roaming (SoR) security check failure(unsuccessful) in a connected mode of a UE in a wireless network. The method includes detecting, by the UE, a stored SoR connected mode control information (SoR-CMCI) comprising a timer associated with a SOR security check not successful criterion. Further, the method includes receiving, by the UE, a SOR information or the SOR_CMCI from a Home Public Land Mobile Network (HPLMN) when the UE is registered with a VPLMN. Further, the method includes detecting, by the UE, whether a SoR security check on the received SOR information or the received SOR_CMCI is successful. Further, the method includes initiating, by the UE, the timer associated with the SOR security check not successful criterion in response to determining that the SoR security check is not successful on the received SOR information or the received SOR_CMCI. Further, the method includes performing, by the UE, the timer associated with SOR security check not successful criterion expiry actions in response to determining that the timer associated with the SOR security check not successful criterion has expired.

In an embodiment, detecting, by the UE, the stored SoR-CMCI comprising the timer associated with the SOR security check not successful criterion includes receiving, by the UE, the SoR CMCI information comprising a timer associated with “SOR security check not successful” criterion from a Home Public Land Mobile Network (HPLMN) or a subscribed Stand-alone Non-Public Network (SNPN) apparatus in the wireless network as part of NAS message or receiving, by the UE, a SOR_CMCI information comprising the timer associated with “SOR security check not successful” criterion that is pre-configured in a ME or a USIM.

In an embodiment, performing, by the UE, the timer associated with the SOR security check not successful criterion expiry actions includes detecting, by the UE, that the timer associated with the SOR security check not successful criterion is expired, determining, by the UE, to perform a PLMN selection, determining, by the UE, that the UE is in the connected state, performing, by the UE, a Non-access stratum (NAS) procedure comprising a deregistration procedure requesting release of all Protocol Data Unit (PDU) sessions and services, determining, by the UE, that the UE enters in an IDLE mode, and attempting, by the UE, to obtain service on a higher priority PLMN by performing PLMN selection procedure by considering the VPLMN as lowest priority.

In an embodiment, the PLMN selection is determined by determining that there is a higher priority PLMN than selected VPLMN in response to determining at least one of the list of available and the allowable PLMNs in the area is available at the UE, and inability of the UE to determine a higher priority PLMN than selected VPLMN in response to determining that the list of available and the allowable PLMNs in the area is not available.

Accordingly, the embodiment herein is to provide a UE for handling SoR security check failure in a connected mode of the UE in a wireless network. The UE includes a SoR security check controller communicatively coupled to a memory and a processor. The SoR security check controller is configured to detect a stored SoR CMCI comprising a timer associated with a SOR security check not successful criterion. Further, the SoR security check controller is configured to receive a SOR information or the SOR_CMCI from a HPLMN when the UE is registered with a VPLMN. Further, the SoR security check controller is configured to detect whether a SoR security check on the received SOR information or the received SOR_CMCI is successful. Further, the SoR security check controller is configured to initiate the timer associated with the SOR security check not successful criterion in response to determining that the SoR security check is not successful on the received SOR information or the received SOR_CMCI. Further, the SoR security check controller is configured to perform the timer associated with SOR security check not successful criterion expiry actions in response to determining that the timer associated with the SOR security check not successful criterion has expired.

These and other aspects of the embodiments herein will be better appreciated and understood when considered in conjunction with the following description and the accompanying drawings. It should be understood, however, that the following de-scriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 is a signalling diagram illustrating a scenario in which SoR security check fails when a UE is registered with a VPLMN, according to the related art;

FIG. 2 is a signalling diagram illustrating a scenario of handling a SoR security check failure in a connected mode of the UE in a wireless network, according to cm-bodiments as disclosed hercin;

FIG. 3 illustrates an overview of a wireless network for handling SoR security check failure in a connected mode of the UE, according to embodiments as disclosed herein;

FIG. 4 illustrates various hardware components of the UE, according to embodiments as disclosed herein; and

FIG. 5 is a flow chart illustrating a method, implemented by the UE, for handling the SoR security check failure in the connected mode of the UE in the wireless network, according to embodiments as disclosed herein.

### MODE FOR THE INVENTION

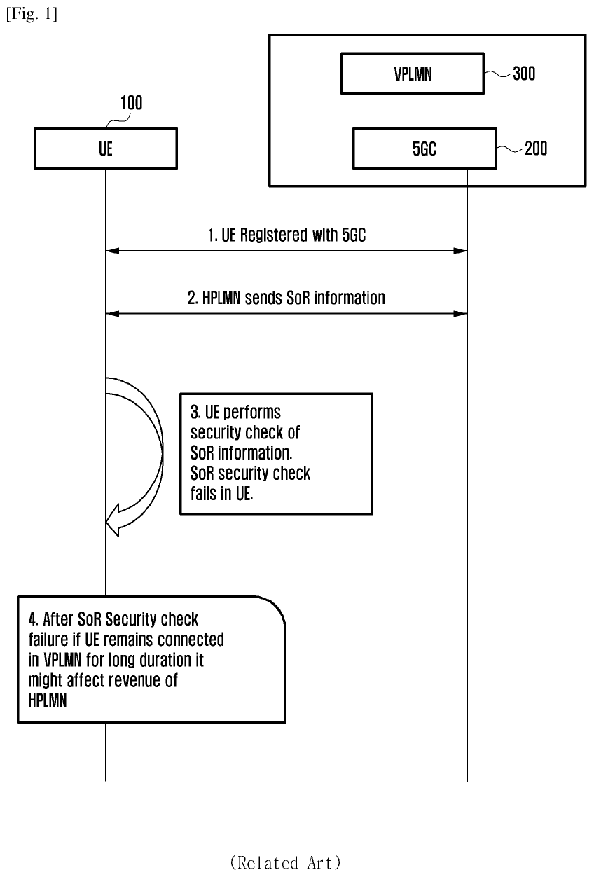

FIG. 1 is a signalling diagram illustrating a scenario in which Steering of Roaming (SoR) security check fails when a UE is registered in a Virtual Public Land Mobile Network (VPLMN) (300), according to the related art;

Referring to the FIG. 1 consider a conventional methods and systems, at 1, the UE (100) is registered with the VPLMN (300) or a Home Public Land Mobile Network (HPLMN) (400a) or a 5GC (200). At 2, a SoR information or SOR_CMCI information reaches to the UE (100) via a Downlink Non Access Stratum (DL NAS) transport message or any other NAS message. At 3, the UE performs SOR security check and it finds SoR security check is not successful either on the SOR information or the SOR_CMCI configuration information received by the UE (100), this is potentially because VPLMN is aware that if SOR information is sent to the UE then UE may select some other higher priority PLMN which may impact the VPLMN revenues hence VPLMN corrupts the SOR information or SOR_CMCI information sent to the UE by HPLMN via VPLMN. At 4, the VPLMN (300) further plans to keep the UE (100) in the connected mode for long time so that the VPLMN (300) can increase its revenue by continuing to provide the service and not allowing UE to select any other VPLMN. The UE (100) is stuck with the VPLMN (300) because the UE (100) is not released to an IDLE state or an INACTIVE state effecting the HPLMN revenue or important services which could have been provided only by higher priority VPLMN. As the UE (100) is in the connected mode it will continue to use the same malicious VPLMN (300) to send or receive the data which increases the VPLMN revenue but impacts the revenue of the HPLMN and UE is not able to go on higher priority VPLMN to receive better services.

Thus, it is desired to address the above-mentioned disadvantages or other shortcomings or at least provide a useful alternative.

The embodiments herein and the various features and advantageous details thereof are explained more fully with reference to the non-limiting embodiments that are illustrated in the accompanying drawings and detailed in the following description. De-scriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly, the embodiment herein is to provide a UE for handling SoR security check failure in a connected mode of the UE in a wireless network. The UE includes a SoR security check controller communicatively coupled to a memory and a processor. The SoR security check controller is configured to detect a stored SoR CMCI comprising a timer associated with a SOR security check not successful criterion. Further, the SoR security check controller is configured to receive a SOR information or the SOR_CMCI from a HPLMN when the UE is registered with a VPLMN. Further, the SoR security check controller is configured to detect whether a SoR security check on the received SOR information or the received SOR_CMCI is successful. Further, the SoR security check controller is configured to initiate(i.e., start) the timer associated with the SOR security check not successful criterion in response to determining that the SoR security check is not successful on the received SOR information or the received SOR_CMCI. Further, the SoR security check controller is configured to perform the timer associated with SOR security check not successful criterion expiry actions in response to determining that the timer associated with the SOR security check not successful criterion has expired.

Based on the proposed method and the proposed UE, the HPLMN configures the “SoR security check timer” as part of SOR-CMCI configuration in the UE. When the UE receives the SOR information, if SOR security check is not successful, the UE starts SoR security check timer (also called as Tsor-CM timer) configured by the HPLMN in the UE. When the SoR security check timer (Tsor-CM) timer expires, the UE executes the deregistration procedure to come into an IDLE state. After coming into IDLE state UE executes PLMN selection procedure to select some other VPLMN.

After security check failure, the UE starts this timer after expiry of this timer the UE will deregister from current VPLMN, release all resources including NAS signaling connection and select some other VPLMN. Thus, the UE is no more dependent on VPLMN to release the NAS signaling connection and thus VPLMN cannot act maliciously.

Referring now to the drawings and more particularly to FIGS. 2-5, where similar reference characters denote corresponding features consistently throughout the figures, there are shown preferred embodiments.

FIG. 2 is a signalling diagram illustrating a scenario of handling the SoR security check failure in the connected mode of a UE (100) in the wireless network (1000), according to the embodiments as disclosed herein. The UE (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IOT) device.

Unlike to the conventional methods and systems (as explained in the FIG. 1), referring to the FIG. 2 consider a proposed method, at 1, the UE (100) is registered or registering with the VPLMN (300) or the 5GC (200). At 2, the HPLMN (400a) sends the SoR information or SOR_CMCI information and SoR security check timer to the UE (100). At 3, the SoR security check fails either of the SOR information or the SOR_CMCI configuration information in the UE (100). The UE (100) starts “SoR security check timer”.

The network (HPLMN (400a) or VPLMN (300)) may provide “SoR security check timer” to control how long UE (100) may remain in connected state with the current VPLMN (300) after SoR security check fails in the UE (100). “SoR security check timer” may be pre-configured either in USIM or ME. This time value may be provided to the UE (100) via any NAS signalling message (e.g., DL NAS transport message) or on the data path or any other medium of transport from the network to the UE (100). This timer can be provided as part of SOR_CMCI configuration to the UE (100).

On stoppage or expiry of the “SoR security check timer” (optionally this timer can be called as Tsor-CM timer and when all other Tsor-CM timers are stopped or expired), if the UE (100) is in the connected mode and has a list of available and allowable PLMNs in the area and based on this list or any other implementation specific means, the UE (100) determines that there is a higher priority PLMN than the selected VPLMN (300), then the UE (100) shall send the NAS message to network (for e.g., deregistration procedure to releases all the established PDN/PDU sessions and wait for the UE (100) to enters idle mode/INACTIVE state and attempts to obtain service on a higher priority PLMN as specified in sub clause 4.4.3.3 of TS 23.122 by acting as if timer T that controls periodic attempts has expired.

On stoppage or expiry of the “SoR security check timer” (optionally this timer can be called as Tsor-CM timer and when all other Tsor-CM timers are stopped or expired), if the UE (100) is in the connected mode and has a list of available and allowable PLMNs in the area and based on this list or any other implementation specific means, the UE (100) determines that there is a higher priority PLMN than the selected VPLMN (300), then the UE (100) shall send the NAS message to network (for e.g., deregistration procedure to releases all the established PDN/PDU sessions and wait for the UE (100) to enters idle mode/INACTIVE state and attempts to obtain service on a higher priority PLMN as specified in sub clause 4.4.3.3 of TS 23.122 by acting as if timer T that controls periodic attempts has expired.

Specific services (may be user controlled or operator defined e.g., Emergency services) may be exempted from this i.e., an infinite timer value will be applied while the UE (100) is using these services or until emergency services ends. During these exempted service usage UE should keep running “SoR security check timer”. If the “SoR security check timer” expired during using these exempted services, once these services ends UE (100) should take the action.

While “SoR security check timer” is running if the UE (100) stops using all services or no other Protocol Data Unit (PDU) session are active, the UE (100) should consider stopping the timer and take the action.

When the last running Tsor-cm timer stops or expires not due to the UE (100) entering idle mode or 5GMM-CONNECTED mode with RRC inactive indication, if:
a) the UE (100) has a list of available and allowable PLMNs in the area and based on this list or any other implementation specific means, the UE (100) determines that there is a higher priority PLMN than the selected VPLMN (300); or
b) the UE (100) does not have a list of available and allowable PLMNs in the area and is unable to determine whether there is a higher priority PLMN than the selected VPLMN (300) using any other implementation specific means;

Further, the UE (100) shall send the NAS message requesting for the release of resources and signalling connection and then UE (100) waits to enter idle mode and attempts to obtain service on a higher priority PLMN as specified in sub clause 4.4.3.3 by acting as if timer T that controls periodic attempts has expired.

When the last running Tsor-cm timer or the SOR security check timer stops or expires not due to the UE (100) entering idle mode or 5GMM-CONNECTED mode with RRC inactive indication (i.e. UE is in the connected mode), then the UE (100) shall send the NAS message requesting for the release of resources and signalling connection and then the UE (100) waits to enter idle mode or Inactive state and attempts to obtain service on a higher priority PLMN as specified in sub clause 4.4.3.3 of TS 23.122 by acting as if timer T that controls periodic attempts has expired.

In yet another embodiment the UE (100) may consider the current camped and selected VPLMN (300) as lower priority while performing PLMN selection, wherever it's specified to perform PLMN selection in this embodiment.

The proposed timer SoR security check timer and Tsor-cm-timer are used inter-changeably in this embodiment.

The SOR security check failure happens or it is considered unsuccessful as described in TS 23.122. i.e., for e.g., when UE's USIM is configured to receive SOR information but the UE (100) has not received it in the initial registration procedure or if the SOR information is received but integrity protection check was not successful.
a. Proposed “SoR security check timer” should start as soon as SoR security check fails in the UE.
b. If the UE (100) handed over to different Radio Access Technology (RAT) or PLMN UE may consider any of the following for SoR security check timer or for any of the Tsor-CM timers as described in the TS 23.122 ?
a) The UE (100) may continue running the timer.
b) The UE (100) may stop the timer. After stopping the timer UE may or may ignore the timer expiry.
c) The UE (100) may restart the timer with its initial value as per the SOR-CMCI configuration.
d) Or remember that Tsor-TM timer has expired in second RAT/core network type (for example EPS) and if the UE goes back to first RAT/core network type (example 5GS) before getting into IDLE mode then UE shall take the actions as discussed below:
i. the UE (100) has a list of available and allowable PLMNs in the area and based on this list or any other implementation specific means, the UE determines that there is a higher priority PLMN than the selected VPLMN (300); or
ii. the UE (100) does not have a list of available and allowable PLMNs in the area and is unable to determine whether there is a higher priority PLMN than the selected VPLMN (300) using any other implementation specific means;
iii. then the UE (100) shall send a NAS message requesting for the release of resources and signalling connection and then UE waits to enter idle mode and attempts to obtain service on a higher priority PLMN as specified in sub clause 4.4.3.3 by acting as if timer T that controls periodic attempts has expired.

Or
iv. the UE (100) shall send a NAS message requesting for the release of resources and signalling connection (or UE can perform local release in all case in this embodiment) and then UE (100) waits to enter idle mode and attempts to obtain service on a higher priority PLMN as specified in sub clause 4.4.3.3 of TS 23.122 by acting as if timer T that controls periodic attempts has expired.

For all the case its specified that “the UE (100) shall send a NAS message requesting for the release of resources and signalling connection as an alternate option the UE (100) can perform local release of NAS signalling connection without peer-to-peer signalling.

Steering of roaming connected mode control information (SOR-CMCI/SOR_CMCI): HPLMN information to control the timing for a UE in connected mode to move to idle mode in order to perform steering of roaming.

Steering of Roaming(SoR) information: This consists of the following HPLMN or subscribed SNPN protected information (see 3GPP TS 33.501 [66]):
a) the following indicators, of whether:
   the UDM requests an acknowledgement from the UE for successful reception of the steering of roaming information.
   the UDM requests the UE to store the SOR-CMCI in the ME, which is provided along with the SOR-CMCI in plain text; and
b) one of the following:
1) one or more of the following:
   list of preferred PLMN/access technology combinations with an indication that it is included;
   SOR-CMCI; or
   SOR-SNPN-SI;
2) a secured packet with an indication that it is included;
3) the HPLMN indication that ‘no change of the “Operator Controlled PLMN Selector with Access Technology” list stored in the UE is needed and thus no list of preferred PLMN/access technology combinations is provided’; or
4) the subscribed SNPN or HPLMN indication that ‘no change of the SOR-SNPN-SI stored in the UE is needed and thus no SOR-SNPN-SI is provided’, and SOR-CMCI, if any.

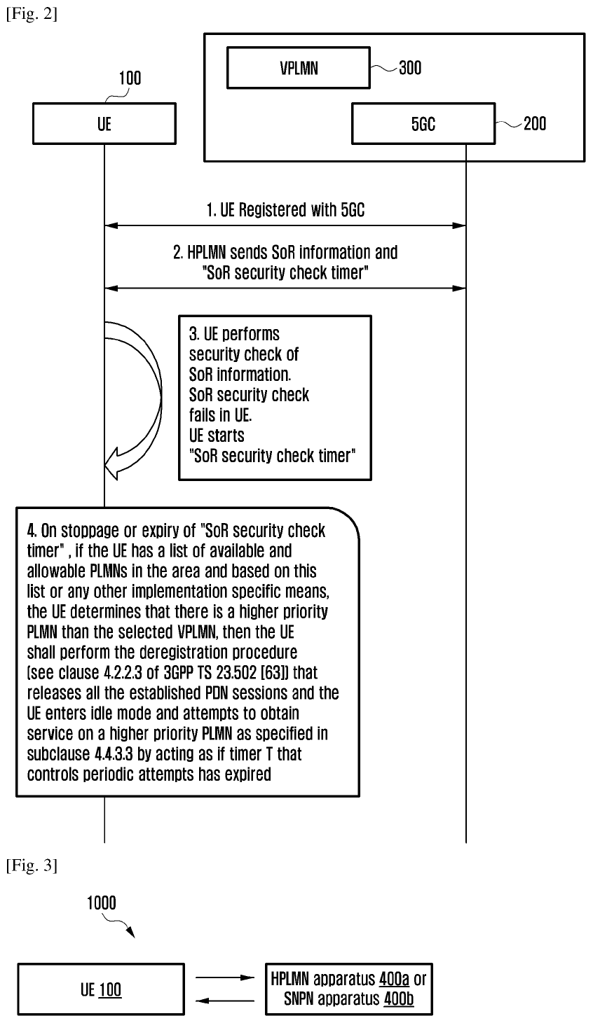

FIG. 3 illustrates an overview of the wireless network (1000) for handling SoR security check failure in the connected mode of the UE, according to embodiments as disclosed herein. In an embodiment, the wireless network (1000) includes the UE (100) and a HPLMN apparatus (400a) or the SNPN apparatus (400b).

The UE (100) is configured to detect the stored SoR CMCI comprising the timer associated with the SOR security check not successful criterion. In an embodiment, the UE (100) is configured to receive the SoR CMCI information comprising the timer associated with “SOR security check not successful” criterion from the HPLMN (400a) or the SNPN apparatus (400b) in the wireless network (1000) as part of NAS message. In another embodiment, the UE (100) is configured to receive the SOR_CMCI information comprising the timer associated with “SOR security check not successful” criterion that is pre-configured in a Mobile Equipment (ME) or a Universal Subscriber Identity Module (USIM).

Further, the UE (100) is configured to receive the SOR information or the SOR_CMCI from the HPLMN (400a) when the UE (100) is registered with the VPLMN (300). Further, the UE (100) is configured to detect that the SoR security check on the received SOR information or the received SOR_CMCI is not successful.

Further, the UE (100) is configured to initiate(i.e. start) the timer associated with the SOR security check not successful criterion in response to determining that the SoR security check is not successful on the received SOR information or the received SOR_CMCI. Further, the UE (100) is configured to perform the timer associated with SOR security check not successful criterion expiry actions in response to determining that the timer associated with the SOR security check not successful criterion has expired.

In an embodiment, the UE (100) is configured to detect that the timer associated with the SOR security check not successful criterion is expired. The UE (100) is configured to determine to perform the PLMN selection. Further, the UE (100) is configured to determine that the UE (100) is in the connected state and perform a NAS procedure comprising a deregistration procedure requesting release of all Protocol Data Unit (PDU) sessions and services. Further, the UE (100) is configured to determine that the UE (100) enters in an IDLE mode and attempt to obtain service on a higher priority PLMN by performing PLMN selection procedure by considering a current VPLMN as lowest priority. The PLMN selection is determined by determining that there is a higher priority PLMN than selected VPLMN in response to determining that a list of available and the allowable PLMNs in the area is available at the UE (100) and inability of the UE (100) to determine a higher priority PLMN than selected VPLMN in response to determining that the list of available and the allowable PLMNs in the area is not available.

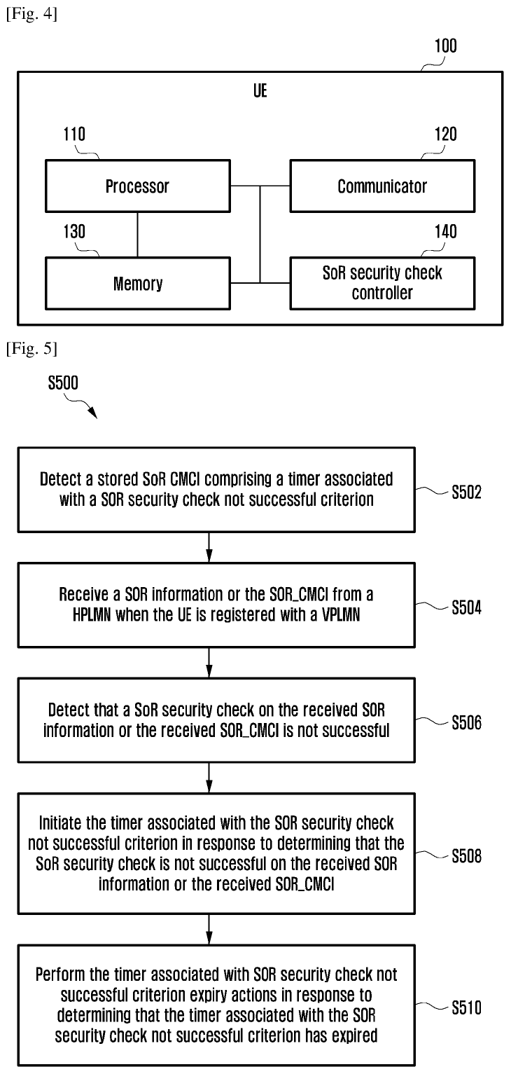

FIG. 4 illustrates various hardware components of the UE (100), according to embodiments as disclosed herein. In an embodiment, the UE (100) includes a processor (110), a communicator (120), a memory (130), and a SoR security check controller (140). The processor (110) is coupled with the communicator (120), the memory (130), and the SoR security check controller (140).

The SoR security check controller (140) is configured to detect the stored SoR CMCI comprising the timer associated with the SOR security check not successful criterion. In an embodiment, the SoR security check controller (140) is configured to receive the SoR CMCI information comprising the timer associated with “SOR security check not successful” criterion from the HPLMN (400a) or the SNPN apparatus (400b) in the wireless network (1000) as part of NAS message. In another embodiment, the SoR security check controller (140) is configured to receive the SOR_CMCI information comprising the timer associated with “SOR security check not successful” criterion that is pre-configured in a Mobile Equipment (ME) or a Universal Subscriber Identity Module (USIM).

Further, the SoR security check controller (140) is configured to receive the SOR information or the SOR_CMCI from the HPLMN (400a) when the UE (100) is registered with the VPLMN (300). Further, the SoR security check controller (140) is configured to detect that the SoR security check on the received SOR information or the received SOR_CMCI is not successful.

Further, the SoR security check controller (140) is configured to initiate the timer associated with the SOR security check not successful criterion in response to determining that the SoR security check is not successful on the received SOR information or the received SOR_CMCI. Further, the SoR security check controller (140) is configured to perform the timer associated with SOR security check not successful criterion expiry actions in response to determining that the timer associated with the SOR security check not successful criterion has expired.

In an embodiment, the SoR security check controller (140) is configured to detect that the timer associated with the SOR security check not successful criterion is expired. The SoR security check controller (140) is configured to determine to perform a PLMN selection. Further, the SoR security check controller (140) is configured to determine that the UE (100) is in the connected state and perform a NAS procedure comprising a deregistration procedure requesting release of all Protocol Data Unit (PDU) sessions and services. Further, the SoR security check controller (140) is configured to determine that the UE (100) enters in an IDLE mode and attempt to obtain service on a higher priority PLMN by performing PLMN selection procedure by considering a current VPLMN as lowest priority.

The SoR security check controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 4 shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 5 is a flow chart (S500) illustrating a method, implemented by the UE (100), for handling the SoR security check failure in the connected mode of the UE (100) in the wireless network (1000), according to embodiments as disclosed herein. The op-crations (S502-S510) are handled by the SoR security check controller (140).

At S502, the method includes detecting the stored SoR CMCI comprising the timer associated with the SOR security check not successful criterion. At S504, the method includes receiving the SOR information or the SOR_CMCI from the HPLMN (400a) when the UE (100) is registered with the VPLMN (300). At S506, the method includes detecting that the SoR security check on the received SOR information or the received SOR_CMCI is not successful.

At S508, the method includes initiating the timer associated with the SOR security check not successful criterion in response to determining that the SoR security check is not successful on the received SOR information or the received SOR_CMCI. At S510, the method includes performing the timer associated with SOR security check not successful criterion expiry actions in response to determining that the timer associated with the SOR security check not successful criterion has expired.

The various actions, acts, blocks, steps, or the like in the flow charts (S500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method for handling Steering of roaming (SoR) security check failure in a connected mode of a UE (100) in a wireless network (1000), wherein the method comprises:
detecting, by the UE (100), a stored SoR connected mode control information (SoR-CMCI) comprising a timer associated with a SOR security check not successful criterion;
receiving, by the UE (100), a SOR information or the SOR_CMCI from a Home Public Land Mobile Network (HPLMN) (400a) when the UE (100) is registered with a VPLMN (300);
detecting, by the UE (100), that a SoR security check on the received SOR information or the received SOR_CMCI is not successful;
initiating, by the UE (100), the timer associated with the SOR security check not successful criterion in response to determining that the SoR security check is not successful on the received SOR information or the received SOR_CMCI; and
performing, by the UE (100), the timer associated with SOR security check not successful criterion expiry actions in response to determining that the timer associated with the SOR security check not successful criterion has expired.

2. The method as claimed in claim 1, wherein detecting, by the UE (100), the stored SoR-CMCI comprising the timer associated with the SOR security check not successfu criterion comprises:
receiving, by the UE (100), the SoR CMCI information comprising the timer associated with “SOR security check not successful” criterion from the HPLMN (400a) or a subscribed Stand-alone Non-Public Network (SNPN) apparatus (400b) in the wireless network (1000) as part of NAS message or receiving, by the UE (100), the SOR_CMCI information comprising the timer associated with “SOR security check not successful” criterion that is pre-configured in a Mobile Equipment (ME) or a Universal Subscriber Identity Module (USIM).

3. The method as claimed in claim 1, wherein performing, by the UE (100), the timer associated with the SOR security check not successful criterion expiry actions comprise:
detecting, by the UE (100), that the timer associated with the SOR security check not successful criterion is expired;
determining, by the UE (100), to perform a PLMN selection;
determining, by the UE (100), that the UE (100) is in the connected state;
performing, by the UE (100), a Non-access stratum (NAS) procedure comprising a deregistration procedure requesting release of all Protocol Data Unit (PDU) sessions and services;
determining, by the UE (100), that the UE (100) enters in an IDLE mode; and
attempting, by the UE (100), to obtain service on a higher priority PLMN by performing PLMN selection procedure by considering the VPLMN (300) as lowest priority.

4. The method as claimed in claim 3, wherein the PLMN selection is determined by:
determining that there is a higher priority PLMN than the selected VPLMN (300) in response to determining that a list of available and the allowable PLMNs in an area is available at the UE (100); and
inability of the UE (100) to determine a higher priority PLMN than the selected VPLMN (300) in response to determining that the list of available and the allowable PLMNs in the area is not available.

5. A UE (100) for handling Steering of roaming (SoR) security check failure in a connected mode of the UE in a wireless network, wherein the UE (100) comprises:
a memory (130);
a processor (110); and
a SoR security check controller (140), communicatively coupled to the memory (130) and the processor (110), configured to:
detect a stored SoR connected mode control information (SoR-CMCI) comprising a timer associated with a SOR security check not successful criterion;
receive a SOR information or the SOR_CMCI from a Home Public Land Mobile Network (HPLMN) (400a) when the UE (100) is registered with a VPLMN (300);
detect that a SoR security check on the received SOR information or the received SOR_CMCI is not successful;
initiate the timer associated with the SOR security check not successful criterion in response to determining that the SoR security check is not successful on the received SOR information or the received SOR_CMCI; and
perform the timer associated with SOR security check not successful criterion expiry actions in response to determining that the timer associated with the SOR security check not successful criterion has expired.

6. The UE (100) as claimed in claim 5, wherein detect the stored SoR-CMCI comprising the timer associated with the SOR security check not successfu criterion comprises:
receive the SoR CMCI information comprising the timer associated with “SOR security check not successful” criterion from the HPLMN (400a) or a subscribed Stand-alone Non-Public Network (SNPN) apparatus (400b) in the wireless network (1000) as part of NAS message or receive the SOR_CMCI information comprising the timer associated with “SOR security check not successful” criterion that is pre-configured in a Mobile Equipment (ME) or a Universal Subscriber Identity Module (USIM).

7. The UE (100) as claimed in claim 5, wherein perform the timer associated with the SOR security check not successful criterion expiry actions comprise:
detect that the timer associated with the SOR security check not successful criterion is expired;
determine to perform a PLMN selection;
determine that the UE (100) is in the connected state;
perform a Non-access stratum (NAS) procedure comprising a deregistration procedure requesting release of all Protocol Data Unit (PDU) sessions and services;
determine that the UE (100) enters in an IDLE mode; and
attempt to obtain service on a higher priority PLMN by performing PLMN selection procedure by considering the VPLMN (300) as lowest priority.

8. The UE (100) as claimed in claim 7, wherein the PLMN selection is determined by:
determining that there is a higher priority PLMN than selected VPLMN (300) in response to determining that a list of available and the allowable PLMNs in the area is available at the UE (100); and
inability of the UE (100) to determine a higher priority PLMN than selected VPLMN (300) in response to determining that the list of available and the allowable PLMNs in the area is not available.
